(19) United States
(12) Patent Application Publication
(10) Pub. No.: US 2016/0081173 A1
(43) Pub. Date: Mar. 17, 2016

(54) X-RAY GENERATION DEVICE AND X-RAY GENERATING UNIT AND HIGH VOLTAGE GENERATING UNIT CONSTITUTING SAME

(71) Applicant: SUNJE CO., LTD, Busan (KR)

(72) Inventors: Dong-hun LEE, Busan (KR); Yong-Chul JUNG, Busan (KR); Sang-Hyo KIM, Busan (KR); Gang-Young SON, Busan (KR); Su-Young LEE, Busan (KR); Sang-Bong SEO, Busan (KR); Jae-hyun LEE, Busan (KR); Sang-Min KIM, Gyeongsangnam-do (KR)

(21) Appl. No.: 14/784,283

(22) PCT Filed: Apr. 15, 2014
(86) PCT No.: PCT/KR2014/003217

§ 371 Date: Oct. 13, 2015

(30) Foreign Application Priority Data
Apr. 15, 2013 (KR) 10-2013-0040779

(51) Int. Cl. H05G 1/10; H05G 1/06

(52) U.S. Cl. CPC H05G 1/10; H05G 1/06

(57) ABSTRACT

A detachable X-ray generating device proposed in the present invention comprises: an X-ray generating unit including an X-ray generating tube for irradiating an X-ray and a first connecting portion connected to the X-ray generating tube through an electric wire; and a high voltage generating unit for receiving an external supply voltage to generate a predetermined high voltage and including a second connection portion through which the generated high voltage is output, wherein the high voltage is supplied to the X-ray generating tube by mutually coupling the first connecting portion and the second connecting portion. An apparatus for removing static electricity according to the present invention has effects of replacement costs reduction, ease of selection of an installation location, thermal insulation, etc. since the apparatus can be mutually separated.

### TECHNICAL FIELD

The present invention relates to an X-ray generation device and to a detachable type and separation type X-ray generation device in which a high-voltage generation unit and an X-ray generation unit can be separated and individually delivered and the X-ray generation unit and the high voltage generator forming the X-ray generation device.

### BACKGROUND ART

In general, in liquid crystal display (LCD), PDP, and semiconductor fabrication processes, fine dust is attached to an LCD, a PDP, or a semiconductor wafer due to the generation of static electricity, or a device is damaged due to the discharge of static electricity. Accordingly, the yield of products is reduced, and thus a side effect, such as a rise of a production cost, is generated.

For this reason, an apparatus for removing static electricity is commonly installed in a clean room in which a semiconductor process is performed.

A prior art for removing such static electricity includes an electrostatic removal device using corona discharge.

The electrostatic removal device adopts a method of generating ions by corona discharge and convecting air using a fan in order to blow ionized air.

In the case of such an electrostatic removal device (also called an X-ray generation device), however, many metal fine particles (tens of thousands/ft3) of 0.01 μM or less are generated and attached to the end of a discharge electrode due to a sputtering phenomenon attributable to the discharge of a high voltage and are then attached around a semiconductor, PDP, or LCD pattern while falling to a forced convection current attributable to the fan, thereby causing many defects.

Furthermore, in the case of the electrostatic removal device using corona discharge, ozone gas generated when a high voltage is discharged is about 4˜10 ppm, thus functioning to cause the attachment of dust. Furthermore, there is a difficulty in that ion balance must be controlled again whenever the balance of generated +ions and ions is frequently changed.

As a solution to such a problem, there has recently been proposed a method of neutralizing or mitigating the static electricity of a body to be electrified by ionizing air using the air ionization action of a soft X-ray.

The soft X-ray radiation type has been known as a method suitable for removing static electricity in a flat panel display fabrication process and a semiconductor fabrication process because fine dust is not generated and air does not need to be subject to convection current.

An example of a soft X-ray radiation type electrostatic removal device includes U.S. Pat. No. 5,949,849.

The static electricity removal device of this patent includes a protection case, an X-ray tube generating a soft X-ray, and a power source device. The X-ray tube includes a bulb, cathode, an output window, an output window support unit, a flange unit, and a target. The internal elements of the X-ray tube and the protection case are coupled thermally and electrically.

Another example of the soft X-ray radiation type electrostatic removal device includes Japanese Patent No. 2951477.

This patent relates to a technology for removing static electricity. The target to which a specific target voltage and a target current are applied is placed at the location in which an X-ray is radiated under an atmosphere in which a specific object to be electrified from which static electricity is to be removed is disposed. Furthermore, the X-ray tube having a beryllium (Be) window is disposed. The static electricity of the specific object is removed under an atmosphere including ions by ionizing elements included in an atmosphere of a region in which an X-ray having a main wavelength of 2 angstrom or more to 20 angstrom or less is radiated from the beryllium window.

Yet another example of the soft X-ray radiation type electrostatic removal device includes an application invented by Hamamatsu Photonics, Japan, entitled “X-ray generator and electrostatic remover using the same” (Korean Patent Application No. 10-2004-0089634).

The X-ray generator disclosed in this invention proposes, as one gist of the technical spirit, that a target having a ground potential is attached to the inner surface of an output window fixed to a conductive and thermal-conductive output window support unit which is installed at the front of a bulb and an X-ray tube having a negative pole for radiating an electron beam to the target and a flange unit configured to have a power source unit for driving the X-ray tube received in a protection container, formed in the output window support unit, and externally protruded are brought in contact with and fixed to the protection container having thermal conductivity. In this case, the X-ray tube and the power source unit for driving the X-ray tube are integrated.

FIGS. 1 to 3 are real photos of a conventional electrostatic removal device. FIG. 1 is an overall appearance diagram, and FIGS. 2 and 3 show internal configurations if an upper case is open. From FIGS. 2 and 3, it may be seen that a high-voltage generation unit 200 is integrated with an X-ray tube 300 (X-ray generation unit) through an electric wire 10.

For reference, as shown in FIGS. 2 and 3, the electrostatic removal device may chiefly include the high-voltage generation unit installed on the left and the X-ray generation unit installed on the right.

The conventional soft X-ray radiation type (hereinafter abbreviated as an X-ray radiation type) basically includes a high-voltage generation unit, that is, an electronic part for being supplied with an external power source and generating a high voltage and an X-ray tube (hereinafter referred to as an X-ray generation unit) for being supplied with a specific high voltage output by the high-voltage generation unit and generating an X-ray although there is some different in the configuration of the soft X-ray radiation type.

The aforementioned conventional soft X-ray radiation type electrostatic removal devices, however, have the following problems because the high-voltage generation unit for being supplied with an external power source and generating a high voltage and the X-ray tube for being supplied with a high voltage from the high-voltage generation unit are integrated into a single case.

First, there is a problem in that the entire product must be replaced because a defective part cannot be replaced if any one of the high-voltage generation unit and the X-ray generation unit is defective.

Second, there is a problem in that the electrostatic removal device must be separated and moved from an installation place if the radiation location or direction of an X-ray is changed in the state in which the electrostatic removal device has been installed because the high-voltage generation unit and the X-ray generation unit are integrated.

Third, there is a possibility that the electronic part of the high-voltage generation unit may cause a malfunction due to high heat generated from the X-ray generation unit.

### DISCLOSURE

### Technical Problem

The present invention has been proposed to solve the aforementioned problems, and an object of the present invention relates to an X-ray generation device and separates and is to provide a high-voltage generation unit and an X-ray generation unit which form a device for removing static electricity using an X-ray.

That is, an object of the present invention is to provide a specific connection coupling unit to the high-voltage generation unit and the X-ray generation unit and to solve the aforementioned problems so that the high-voltage generation unit and the X-ray generation unit are detached if necessary.

To this end, an object of the present invention is to provide an X-ray generation device including the high-voltage generation unit and the X-ray generation unit which can be detached and to provide the separation type high-voltage generation unit and the separation type X-ray generation unit.

### Technical Solution

A detachable X-ray generation device proposed by the present invention includes an X-ray generation unit which includes an X-ray generation tube for radiating an X-ray and a first connection coupling unit connected to the X-ray generation tube through electric wires and a high-voltage generation unit which includes a second connection coupling unit for receiving an external supply voltage, generating a specific high voltage, and outputting the generated high voltage. The high voltage is supplied to the X-ray generation tube by coupling the first connection coupling unit and the second connection coupling unit which are detachable from each other.

In the present invention, if the first connection coupling unit and the second connection coupling unit coupling the X-ray generation unit and the high-voltage generation unit are separated, the X-ray generation unit and the high-voltage generation unit are physically separated.

Furthermore, the X-ray generation unit includes a first case in which the X-ray generation tube and the first connection coupling unit are seated, the high-voltage generation unit includes a second case in which the second connection coupling unit is seated, and the first and the second cases are independent.

### Advantageous Effects

The X-ray generation device including the detachable high-voltage generation unit and the detachable X-ray generation unit and the high-voltage generation unit and the X-ray generation unit forming the X-ray generation device, proposed by the present invention, have the following advantages compared to a conventional electrostatic removal device.

First, unlike in a prior art in which the entire product must be replaced if any one of the high-voltage generation unit and the X-ray generation unit is defective, in the present invention, an economic burden can be reduced from a viewpoint of a company which uses an electrostatic removal device because the high-voltage generation unit or the X-ray generation unit can be individually replaced.

Second, in the case of the present invention, the direction in which the X-ray generation unit radiates light can be freely selected regardless of the place where the high-voltage generation unit is installed because the high-voltage generation unit and the X-ray generation unit are detachably connected through the connection coupling unit. For example, if a fabrication line installed in a semiconductor clean room or the location where some equipment is installed is changed, the place and direction in which the X-ray generation unit is installed can be freely controlled, if necessary.

Third, since the X-ray generation unit which emits much heat may be isolated from the high-voltage generation unit and freely installed, the malfunction of an electronic circuit attributable to the generation of a high voltage due to heat generated by the X-ray generation unit can be reduced. In particular, in the case of a conventional integration type high-voltage generation unit, the design of an insulation structure was important. If a separation type electrostatic removal device is configured as in the present invention, however, the insulation structure can be lightly configured.

### DESCRIPTION OF DRAWINGS

FIGS. 1 to 3 are real photos of a conventional X-ray radiation type electrostatic removal device including a high-voltage generation unit and an X-ray generation unit.

FIG. 4 is an example of a separation type X-ray generation device proposed by the present invention.

FIGS. 5 to 11 are reference diagrams illustrating the configuration of the X-ray generation device of FIG. 4 in more detail.

FIGS. 12˜14 are an embodiment illustrating the concept of the separation type X-ray radiation type X-ray generation device proposed by the present invention.

FIGS. 15˜17 are another embodiment illustrating the concept of the separation type X-ray radiation type X-ray generation device proposed by the present invention.

FIGS. 18˜20 are yet another embodiment illustrating the concept of the separation type X-ray radiation type X-ray generation device proposed by the present invention.

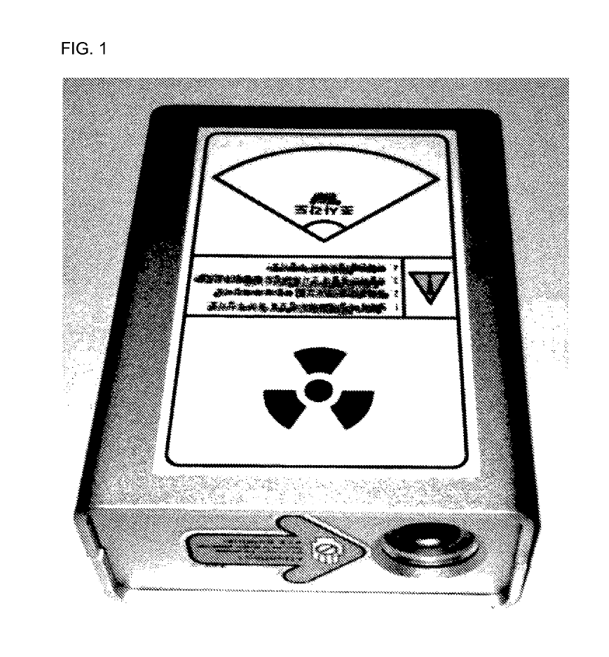

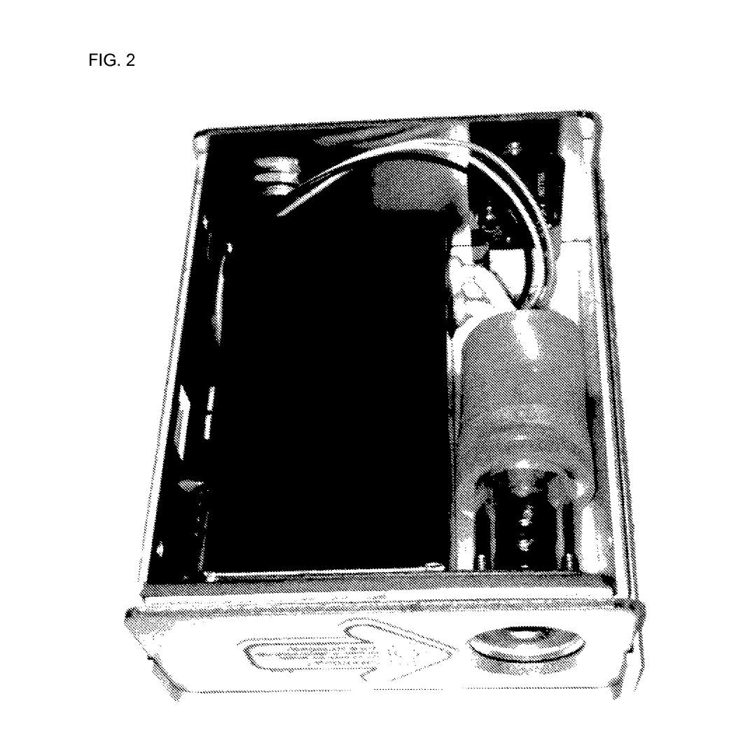

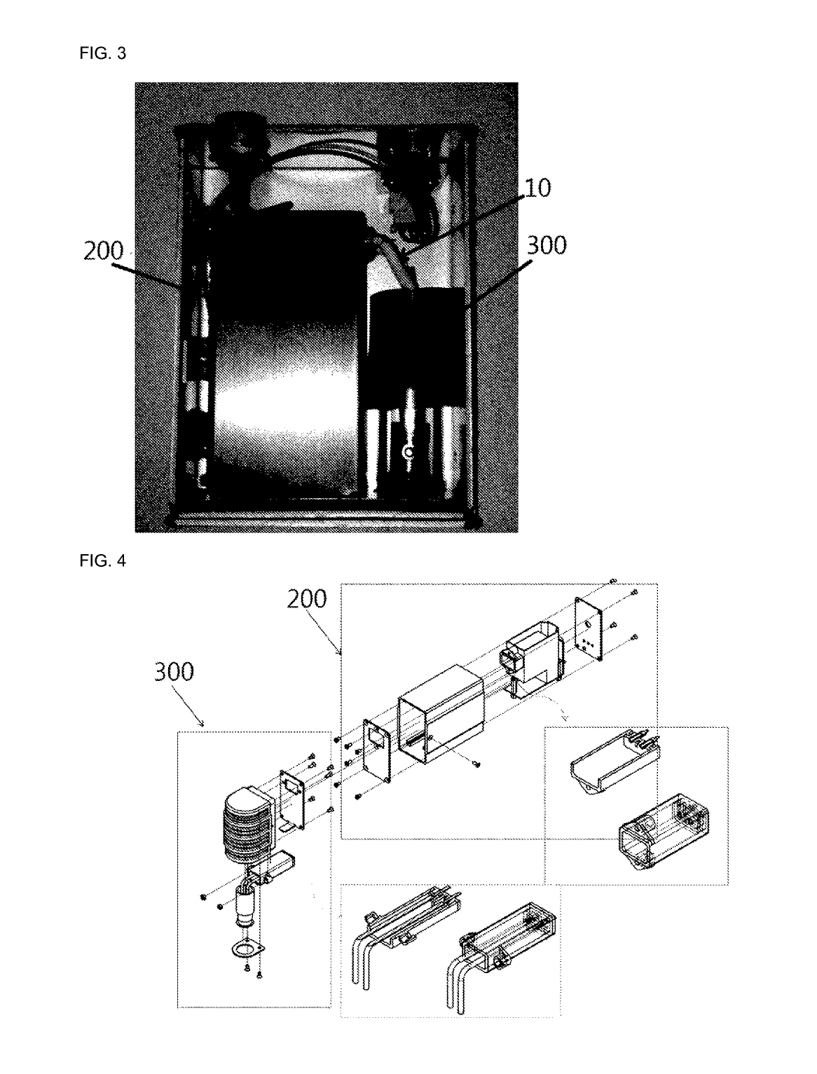

### MODE FOR INVENTION

Hereinafter, detachable and separation type X-ray generation devices proposed by the present invention are described with reference to the drawings.

An object of an X-ray generation device, that is, an electrostatic removal device proposed by the present invention, is to enable a selective replacement in such a manner that an X-ray generation unit for radiating an X-ray and a high-voltage generation unit for applying (supplying) a specific voltage to the X-ray generation unit are configured to be detachable.

Accordingly, the present invention proposes structures having various shapes in which a specific connection coupling unit is provided to the output terminal of the high-voltage generation unit and the input terminal of the X-ray generation unit and the high-voltage generation unit and the X-ray generation unit are detachable, if necessary.

FIG. 4 is an example of a separation type X-ray generation device proposed by the present invention.

As shown in FIG. 4, the X-ray generation device of the present invention includes an X-ray generation unit 300 for radiating an X-ray and a high-voltage generation unit 200.

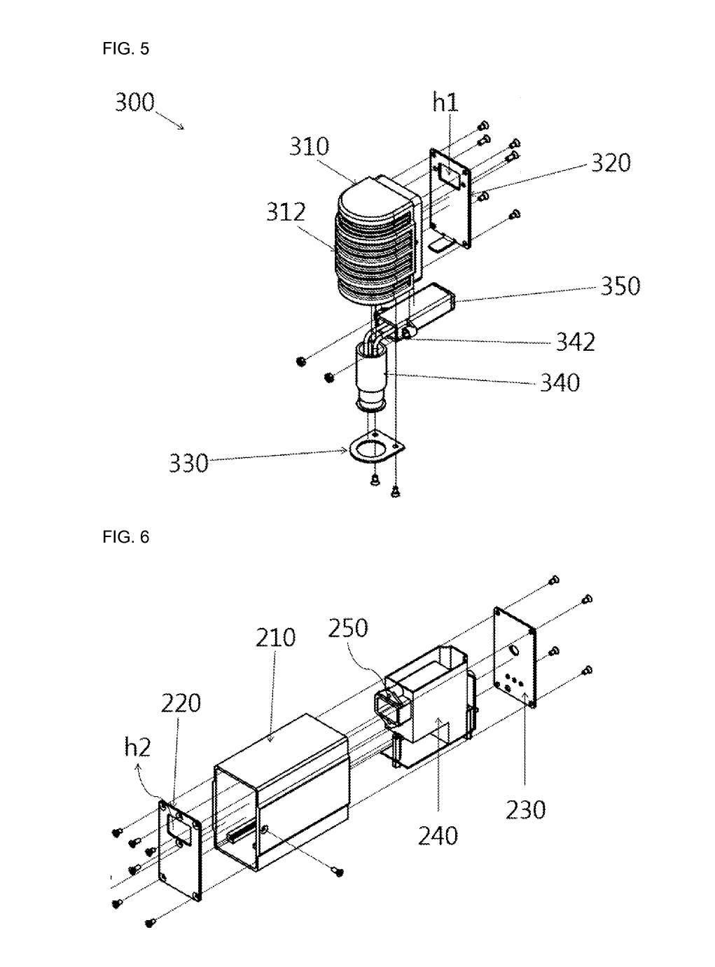

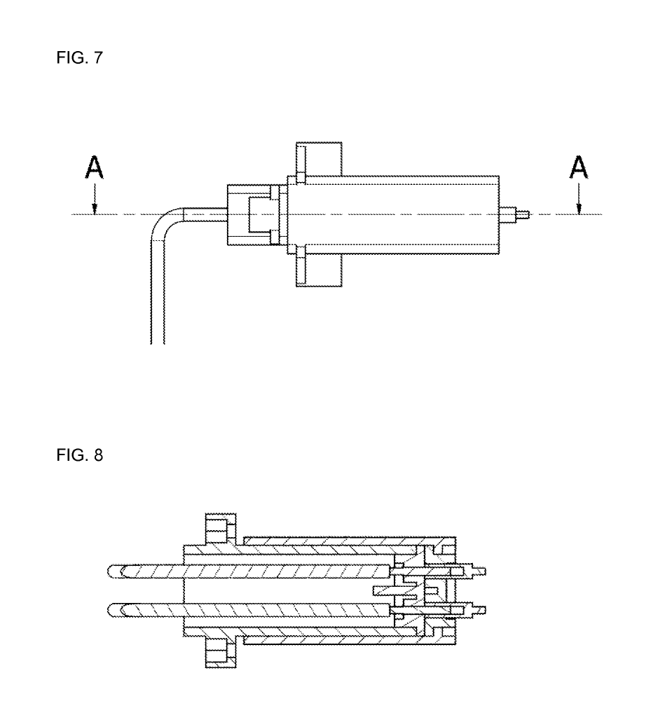

FIGS. 5 and 6 are enlarged diagrams of the X-ray generation unit 300 and the high-voltage generation unit 200 which form the X-ray generation device shown in FIG. 4.

As shown in FIG. 5, the X-ray generation unit 300 includes a semi-cylindrical case 310 which has a top sealed, a right blocking plate 320 which seals an open region on the right of the case 310 by assembly, and the lower blocking plate 330 which seals an open region at the bottom of the case 310 by assembly. A heat dissipation plate 312 has been designed in the outside of the case 310.

An X-ray generation tube 340 and a connection coupling unit 350 connected to the X-ray generation tube 340 through conductive wires 342 are seated in the semi-cylindrical case 310.

As shown in FIG. 6, the high-voltage generation unit 200 consists of an outward appearance, including a box-shaped case 210 which have a left and right open, a left blocking plate 220 which seals the left open region of the case 210 by assembly, and a right blocking plate 230 which seals the right open region of the case 210 by assembly.

A high voltage generator 240 for being supplied with an external power source and generating a high voltage is seated in the box-shaped case 210.

As shown in FIG. 6, the connection coupling unit 250 is formed on the upper side of the high voltage generator 240. The connection coupling unit 250 is coupled with the connection coupling unit 350 of the X-ray generation unit 300 and applies a high voltage to the X-ray generation unit 300.

The structure of the X-ray generation device proposed by the invention is further described below with reference to FIGS. 4 to 6.

The X-ray generation device of the present invention has been proposed to provide a replacement time and an economic effect by replacing only a defective element if the X-ray generation unit 300 and the high-voltage generation unit 200 are selectively separated or any one of the X-ray generation unit 300 and the high-voltage generation unit 200 is defective.

As shown, the connection coupling unit 350 of the X-ray generation unit 300 and the connection coupling unit 250 of the high-voltage generation unit 200 are configured to be mutually inserted, coupled, and separated.

Accordingly, there is an advantage in that the X-ray generation unit 300 or the high-voltage generation unit 200 can be easily replaced at any time, if necessary.

For reference, referring to FIG. 5, one end of the connection coupling unit 350 seated inside the X-ray generation unit 300 is configured to be partially protruded through an opening portion h1 formed in the right blocking plate 320.

When the X-ray generation unit 300 and the high-voltage generation unit 200 are combined, the right blocking plate 320 of the X-ray generation unit 300 is closely attached and coupled to the left blocking plate 220 of the high-voltage generation unit 200, and the connection coupling unit 350 is inserted into and coupled to the connection coupling unit 250. That is, an opening portion h2 formed in the left blocking plate 220 is configured to be matched up with the opening portion h1 of the right blocking plate 320. The connection coupling unit 350 is inserted into the opening portion h2 in such a way as to be guided into the opening portion h2. In the case of the present invention, in order to prevent the introduction of external air if the connection coupling unit 350 is inserted into the connection coupling unit 250 of the high-voltage generation unit, a groove on which an O-ring is mounted may be formed in the outer circumference surface of the connection coupling unit so that the O-ring is mounted on the connection coupling unit 350 in the state in which the connection coupling unit 350 has been inserted in order to seal a portion of the connection coupling unit 350 coming in contact with the left blocking plate 220.

For reference, FIG. 4 illustrates a cross-sectional structure of the connection coupling unit 350 and the connection coupling unit 250 which perform a connector function proposed by the present invention.

As shown in FIG. 4, the connection coupling unit 350 has a male connection connector shape, and the connection coupling unit 250 has a female connection connector shape.

Such a combination type of the connection connectors 350 and 250 may be implemented in various shapes for electrically coupling the X-ray generation unit 300 and the high-voltage generation unit 200.

For reference, the X-ray generation tube 340 proposed by the present invention is a concept including all X-ray generation tube of various structures which have been manufactured or who applications have already been filed by Sunje Co., Ltd. and all types of X-ray generation tubes for generating a soft X-ray.

The high voltage generator 240 of the high-voltage generation unit 200 proposed by the present invention includes an electronic circuit for being supplied with an external power source and generating a specific high voltage, but the electronic circuit has not been shown in detail because it is not a core element of the present invention.

FIGS. 7 and 8 are a side view of the connection coupling unit 350 shown in FIG. 4 and a cross-sectional view of the connection coupling unit 350 taken along line A-A.

As shown, the connection coupling unit 350 of the present invention has the conductive wires 342 formed therein, and the ends of the conductive wires 342 are connected to a conduction terminal. The conduction terminal is exposed to the outside of the connection coupling unit 350. Accordingly, the conduction terminal is configured to be inserted into another conduction terminal formed in the connection coupling unit 250 because it is inserted into the connection coupling unit 250 (refer to FIG. 4).

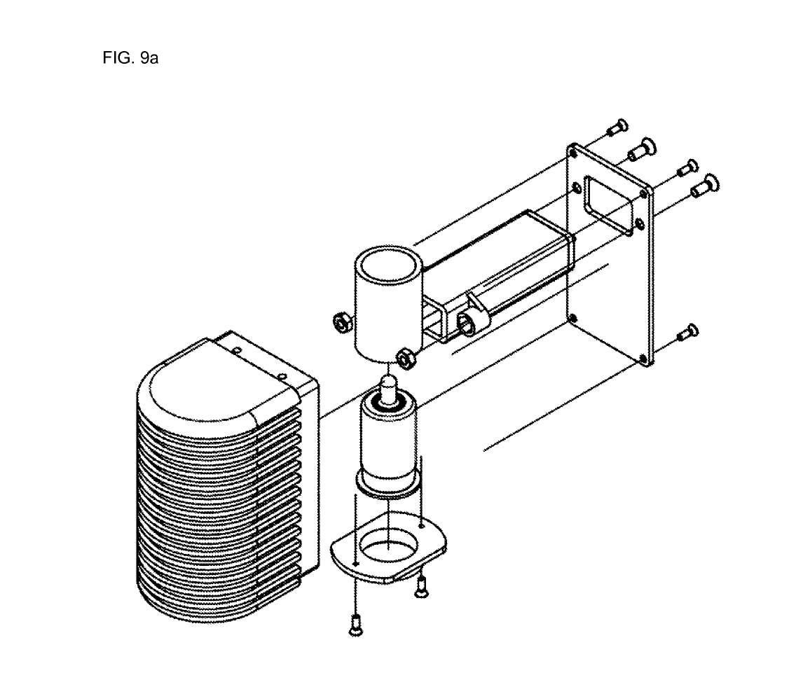

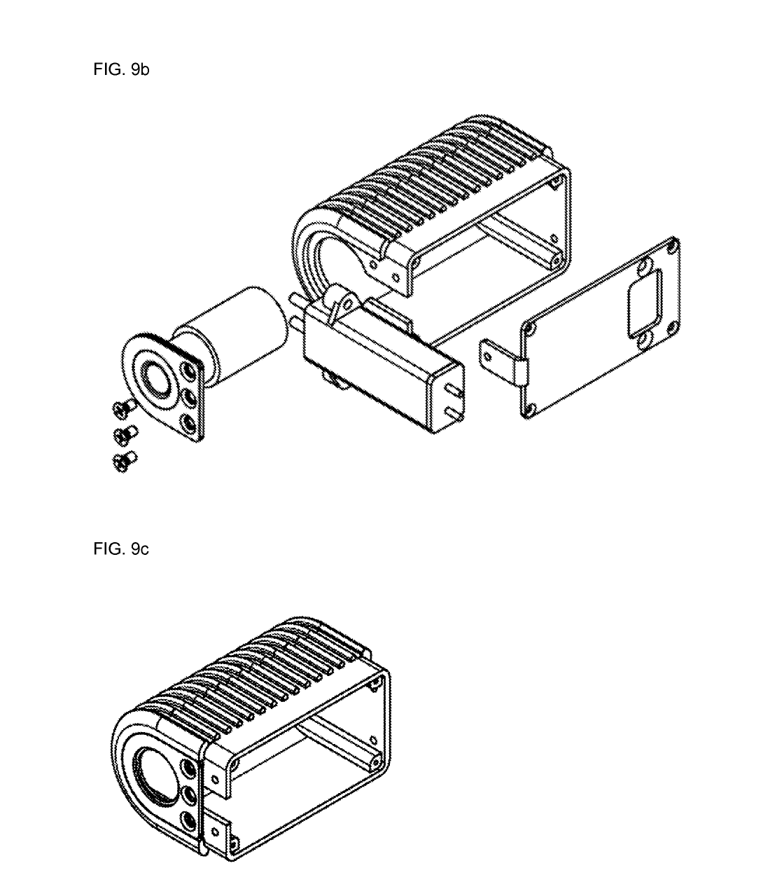

FIGS. 9a, 9b, and 9c are exploded views of the X-ray generation unit 300 which are viewed at various angles in accordance with an embodiment of the present invention.

From FIGS. 9a, 9b, and 9c, it may be seen that the X-ray generation tube 340 and the connection coupling unit 350 are seated in the internal space of the semi-cylindrical case 310.

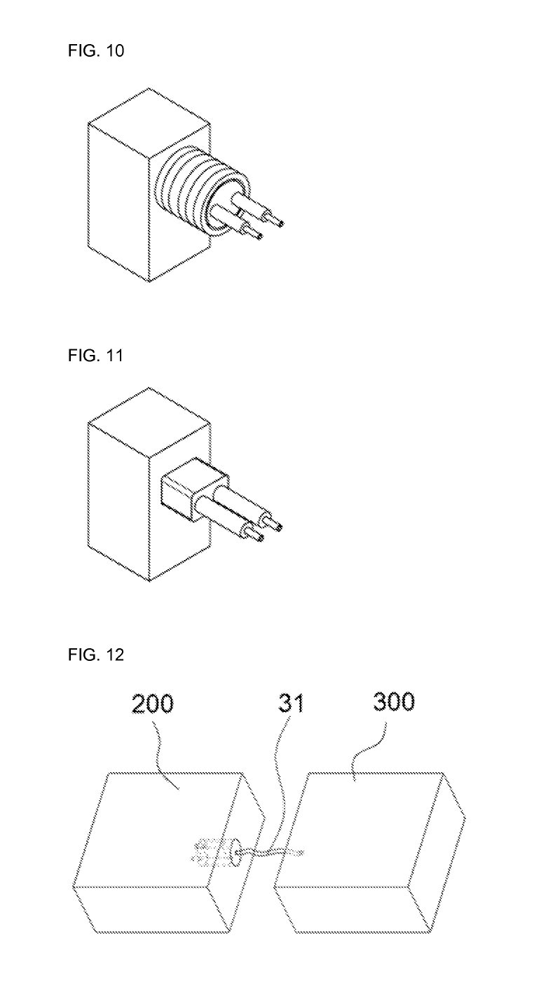

Furthermore, the connection coupling unit 350 proposed by the present invention may be fabricated to have various shapes. FIGS. 10 and 11 are embodiments regarding other shapes of the connection coupling unit 350.

If the connection coupling unit 350 has the shapes shown in FIGS. 10 and 11, the connection coupling unit 250 of the high-voltage generation unit 200 may preferably be configured to be coupled with the connection coupling unit 350.

That is, in the present invention, the connection coupling unit 350 may include two conductive electrodes having protrusion structures. The connection coupling unit 250 corresponding to the connection coupling unit 350 may be configured to have two reception type conductive electrodes.

The X-ray generation device, that is, an electrostatic removal device according to the present invention described so far, is configured so that the X-ray generation unit 300 and the high-voltage generation unit 200 are separated and delivered. If a product is produced as described above, there are advantages, such as a reduction of a replacement cost, the easiness of the selection of an installation place, and the blocking of heat.

Meanwhile, in the present invention, the aforementioned coupling unit has been basically described as the type of a protrusion type conductive electrode and a reception type conductive electrode for receiving the protrusion type conductive electrode, but this is only an example for implementing the technical spirit of the present invention. Such a detachable separation type electrostatic removal device may be fabricated to have a male and female coupling structure of various forms within the limit that a function is not deteriorated.

For example, the coupling unit may be modified into a coaxial cable structure or a screw fastening structure. Such a simple change of the structure of the coupling unit may be considered to correspond to the coupling unit proposed by the present invention, that is, a separation type detachable structure which is the technical spirit of the present invention.

Another embodiment of the present invention is described below with reference to FIGS. 12 to 14.

FIGS. 12˜14 are diagrams illustrating the technical spirit of another embodiment of the separation type X-ray generation device proposed by the present invention.

As shown, the X-ray generation device proposed by the present invention basically includes the high-voltage generation unit 200 and the X-ray generation unit 300.

In the present invention, the high-voltage generation unit 200 generally refers to an electronic part for generating a specific voltage necessary for the X-ray generation unit to generate a specific X-ray. The X-ray generation unit 300 means an X-ray tube for being supplied with a specific high voltage from the high-voltage generation unit 200 and generating an X-ray (as known, the X-ray tube includes an electrode terminal for receiving a high voltage, and one terminal of the electric wire 31 is connected to the electrode terminal by soldering). The X-ray generation unit 300 is a concept including a radiation window through which an X-ray is radiated.

In general, in a prior art, the high-voltage generation unit and the X-ray tube have been integrated into a single case as described above. In contrast, the present invention proposes a method of embedding the high-voltage generation unit 200 and the X-ray generation unit 300 in different cases and coupling them, as shown in FIGS. 12˜14.

That is, the X-ray generation device proposed by the present invention is configured so that the high-voltage generation unit 200 and the X-ray generation unit 300 can be separated. In other words, the high-voltage generation unit 200 and the X-ray generation unit 300 are detachable.

For reference, in the present invention, the high-voltage generation unit 200 is an element for generating a specific voltage which is necessary for the X-ray generation unit 300 to radiate an X-ray. A portion from which a high voltage is output is defined as an output terminal, and a portion to which the high voltage is supplied is defined as the input terminal of the X-ray generation unit 300.

The terms: the output terminal and the input terminal are used as concepts which are almost similar to coupling units 20 and 30, but should be understood as concepts including electric wires 21 and 31 to be described later.

As shown in FIGS. 12˜14, the specific coupling units 20 and 30 are respectively formed in the high-voltage generation unit 200 and the X-ray generation unit 300. The easy attachment and detachment of the high-voltage generation unit 200 and the X-ray generation unit 300 using the coupling units 20 and 30 is the technical spirit of the present invention.

In FIGS. 12˜14, a high voltage generated by the high-voltage generation unit 200 is supplied to the coupling unit 30 of the X-ray generation unit 300 through the coupling unit 20, that is, a high voltage output terminal. The supplied high voltage is supplied to the X-ray generation unit 300t through the electric wire 31.

In FIGS. 12˜14, the coupling unit 20 of the high-voltage generation unit 200 is preferably formed on one side of the case of the high-voltage generation unit, and the coupling unit 30 of the X-ray generation unit 300 is preferably connected to the other end of the electric wire 31 having one end connected to the X-ray generation unit 300.

In the case of the present invention, the place where the X-ray generation unit 300 is to be installed may be selected regardless of the place where the high-voltage generation unit 200, if necessary, by providing the electric wire 31 having a length of about 1 m.

Conceptually, in FIGS. 12˜14, the coupling unit 20 of the high-voltage generation unit 200 may be said to be a female coupling unit, and the coupling unit 30 of the X-ray generation unit 300 may be said to be a male coupling unit.

That is, the coupling unit 30 of the X-ray generation unit 300, that is, the male coupling unit, may be inserted into and coupled to the coupling unit 20 of the high-voltage generation unit 200, that is, the female coupling unit, and may be detached from the coupling unit 20, if necessary.

More specifically, the coupling unit 30 of the X-ray generation unit 300, that is, the male coupling unit, may be implemented using a protrusion type conductive electrode implemented in various ways, such as a plug type and a jack type. The coupling unit 20 of the high-voltage generation unit 200 corresponding to the coupling unit 30 may be configured to receive the coupling unit 30 and maintain a conduction state.

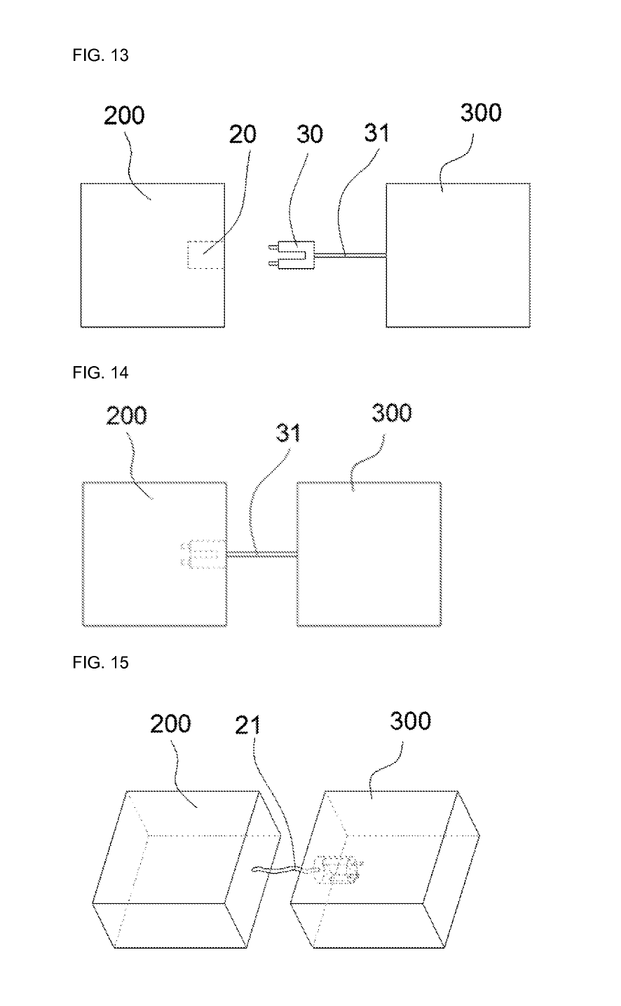

FIGS. 15˜17 are another embodiment of the detachable X-ray generation device proposed by the present invention and illustrate a case where the shapes of the coupling units have been transposed.

That is, in FIGS. 12˜14, the female coupling unit has been formed in the high-voltage generation unit 200, and the male coupling unit has been formed in the X-ray generation unit. In contrast, the embodiment shown in FIGS. 15˜17 illustrates a case where the male coupling unit has been formed in the high-voltage generation unit 200 and the female coupling unit has been formed in the X-ray generation unit.

As shown in FIGS. 15˜17, the coupling unit 20 of the high-voltage generation unit 200 is connected to the other end of the electric wire 21 having one end connected to the X-ray generation unit 300. The coupling unit 30 of the X-ray generation unit 300 is preferably formed on one side of the case of the X-ray generation unit.

As in FIGS. 12˜14, in the case of FIGS. 15˜17, the coupling unit 20 of the high-voltage generation unit 200 may be said to be a male coupling unit, and the coupling unit 30 of the X-ray generation unit 300 may be said to be a female coupling unit.

That is, the coupling unit 20 of the high-voltage generation unit 200, that is, the male coupling unit, may be inserted into and coupled to the coupling unit 30 of the X-ray generation unit 300, that is, the female coupling unit, and is configured to be detachable from the coupling unit 30, if necessary.

More specifically, the coupling unit 20 of the high-voltage generation unit 200, that is, the male coupling unit, may be implemented in various ways, such as a plug type and a jack type. The coupling unit 30 of the X-ray generation unit 300 corresponding to the coupling unit 20 is preferably configured to receive the coupling unit 20 and maintain a conduction state.

As in FIGS. 12˜14, in FIGS. 15˜17, both the aforementioned coupling units 20 and 30 are preferably formed of electrodes made of conductive materials.

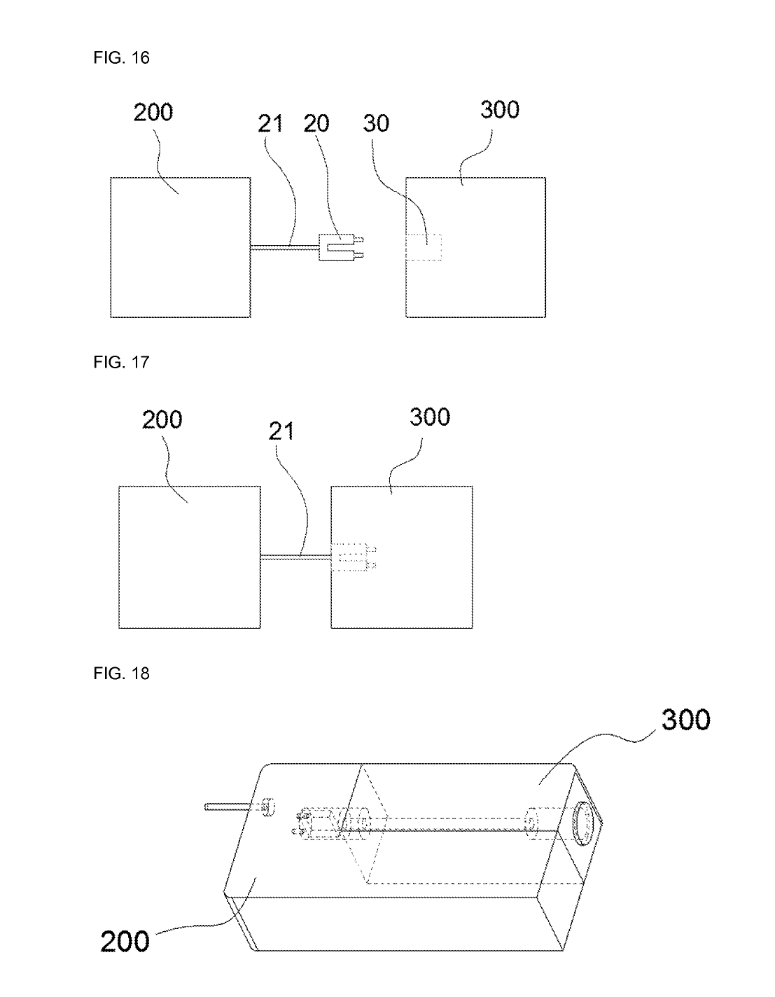

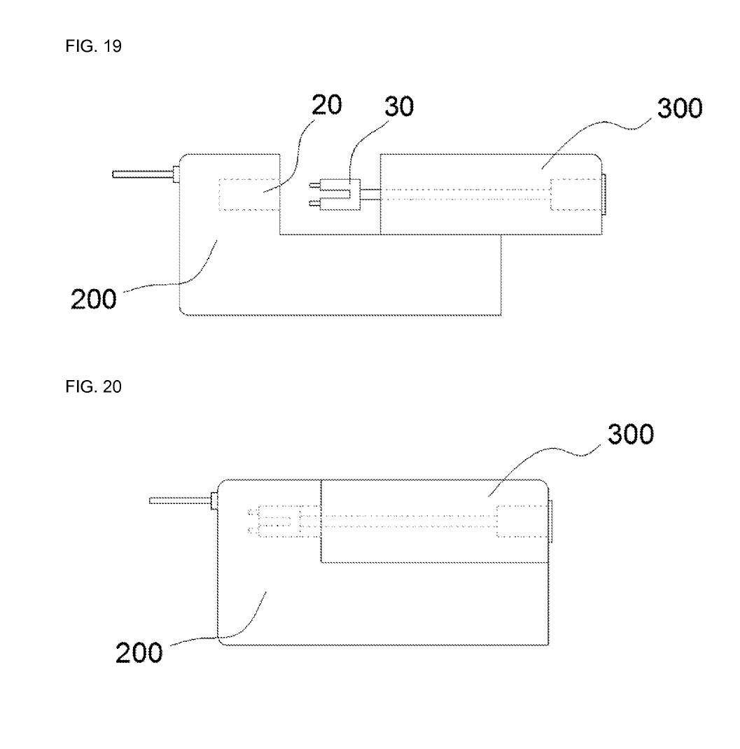

FIGS. 18˜20 show yet another embodiment of an X-ray generation device, that is, a detachable static electricity removal device having a structure (codeless structure) in which the aforementioned electric wires 31 and 21 have been removed in FIGS. 12˜14 and FIGS. 15˜17.

Accordingly, in the detachable separation type X-ray generation device shown in FIGS. 18˜20, the high-voltage generation unit 200 and the X-ray generation unit 300 may be configured to have an integration type product in appearance when they are coupled.

For reference, in the coupling unit of the present invention, since an alternating current voltage is applied, the male coupling unit may include two conductive electrodes having protrusion structures, and the female coupling unit corresponding to the male coupling unit may include two reception type conductive electrodes.

In the X-ray generation device described so far according to the present invention, the high-voltage generation unit 200 and the X-ray generation unit 300 forming the X-ray generation device are separated and delivered. If a product is fabricated as described above, there may be advantages, such as a reduction of a replacement cost, the easy selection of an installation place, and the blocking of heat.

Meanwhile, in the present invention, the aforementioned coupling unit has been basically described as the type of a protrusion type conductive electrode and a reception type conductive electrode for receiving the protrusion type conductive electrode, but is only an example for implementing the technical spirit of the present invention. Such a detachable separation type electrostatic removal device may be fabricated to have a male and female coupling structure of various forms within the limit that a function is not deteriorated.

For example, the coupling unit may be modified into a coaxial cable structure or a screw fastening structure. Such a simple change of the structure of the coupling unit may be considered to correspond to the coupling unit proposed by the present invention, that is, a separation type detachable structure which is the technical spirit of the present invention.

Meanwhile, if the high-voltage generation unit and the X-ray generation unit described with reference to FIGS. 12˜20 are provided as separate parts in the state in which they include respective coupling units according to the technical spirit of the present invention, they may be represented as a high voltage generation device and an X-ray generation device.

That is, in the present invention, the high-voltage generation unit and the X-ray generation unit are coupled and named an electrostatic removal device or an X-ray generation device. If the high-voltage generation unit and the X-ray generation unit are separately delivered, they may be named a high voltage generation device and an X-ray generation device, respectively.

The technical spirit of the present invention described so far relates to the device for removing static electricity by generating an X-ray. It is however evident that the device may be likewise applied to all types of X-ray generation devices including an X-ray generation unit for being supplied with a high voltage and generating an X-ray.

Accordingly, a device for generating an X-ray by detachably configuring the technical concept of the present invention, that is, the X-ray generation unit and the high-voltage generation unit, is included in the scope of the present invention within the limit of a construction described in the claims regardless of its use.

For example, the present invention should be interpreted as being identically applied to all types of X-ray generation devices using an X-ray tube to which a high voltage is supplied regardless of the use of a device for generating an X-ray (e.g., the removal of static electricity or air purification).

1. An X-ray generation device, comprising:
an X-ray generation unit which comprises an X-ray generation tube for radiating an X-ray and a first connection coupling unit connected to the X-ray generation tube through electric wires; and
a high-voltage generation unit which comprises a second connection coupling unit for receiving an external supply voltage, generating a specific high voltage, and outputting the generated high voltage,
wherein the high voltage is supplied to the X-ray generation tube by coupling the first connection coupling unit and the second connection coupling unit which are detachable from each other.

2. The X-ray generation device of claim 1, wherein if the first connection coupling unit and the second connection coupling unit coupling the X-ray generation unit and the high-voltage generation unit are separated, the X-ray generation unit and the high-voltage generation unit are physically separated.

3. The X-ray generation device of claim 2, wherein:
the X-ray generation unit comprises a first case in which the X-ray generation tube and the first connection coupling unit are seated,
the high-voltage generation unit comprises a second case in which the second connection coupling unit is seated, and
the first and the second cases are independent.

4. The X-ray generation device of claim 3, wherein a heat dissipation plate is formed outside the first case.

5. An X-ray generation device comprising a high-voltage generation unit and an X-ray generation unit which are the detachable, wherein an input terminal of the X-ray generation unit connected to an output terminal of the high-voltage generation unit has a detachable structure.

6. The X-ray generation device of claim 5, wherein the input terminal of the X-ray generation unit comprises a first coupling unit which is inserted into and coupled to the output terminal of the high-voltage generation unit.

7. The X-ray generation device of claim 6, wherein the output terminal of the high-voltage generation unit comprises a second coupling unit coupled to the first coupling unit.

8. The X-ray generation device of claim 7, wherein the first coupling unit comprises two conductive electrodes.

9. The X-ray generation device of claim 8, wherein the second coupling unit comprises two conductive electrodes detachably coupled to the two conductive electrodes of the first coupling unit.

10. An X-ray generation unit used in an X-ray generation device, comprises:
a coupling unit detachable from a high-voltage generation unit for supplying a high voltage to the X-ray generation unit.

11. The X-ray generation unit of claim 10, wherein the coupling unit is detachably coupled to an output terminal of the high-voltage generation unit and is supplied with the high voltage.

12. A high-voltage generation unit for an X-ray generation device, wherein an output terminal of the high-voltage generation unit comprises a coupling unit supplied with a high voltage and detachable from an X-ray generation unit.

13. The high-voltage generation unit of claim 12, wherein the coupling unit of the high-voltage generation unit is detachably coupled to an input terminal of the X-ray generation unit and supplies the high voltage.
